(19) United States
(12) Patent Application Publication
(10) Pub. No.: US 2015/0003240 A1
(43) Pub. Date: Jan. 1, 2015

(54) ADAPTIVE CALL ROUTING IN IP NETWORKS

(71) Applicant: ROCKSTAR CONSORTIUM US LP, Plano, TX (US)

(72) Inventors: Tadeusz DRWIEGA, Kanata (CA); Xiao Gao LIU, Kanata (CA)

(21) Appl. No.: 14/341,611

(22) Filed: Jul. 25, 2014

Related U.S. Application Data
(63) Continuation of application No. 11/357,090, filed on Feb. 21, 2006.

(51) Int. Cl. H04L 12/927; H04L 29/06; H04L 12/26; H04L 12/819

(52) U.S. Cl. CPC H04L 47/801; H04L 47/215; H04L 65/80; H04L 43/0852
USPC 370/230

(57) ABSTRACT

A method of adaptively routing voice packets in an IP network receiving a request for a new call at a voice gateway, determining a destination gateway for the new call, determining an availability of at least one route for routing the new call across the IP network to the destination gateway, and deciding whether to admit the new call into the IP network based on whether a route is available over which voice packets for the new call can be routed. A call admission decision is made based on whether a direct, single-path route or a two-path route is available, where each path is an LSP tunnel whose availability is determined using a token bucket technique. If no route is available, the voice gateway does not admit the call into the IP network.

### CROSS-REFERENCE TO RELATED APPLICATIONS

This application is a Continuation of U.S. patent application Ser. No. 11/357,090, the entire content of which is hereby incorporated by reference.

### TECHNICAL FIELD

The present invention relates in general to packet networks and, in particular, to Voice-over-IP (VoIP).

### BACKGROUND OF THE INVENTION

FIG. 1 shows a prior-art network paradigm for routing voice packets over an IP network 10 (such as in a VoIP implementation). In this prior-art paradigm, voice gateways 12 are connected to edge routers 14. Call servers 16 are not involved in selecting paths for calls. Call servers 16 are not aware of the packet paths. When a call request arrives at a voice gateway 12, the voice gateway queries the originating call server 16 to determine destination information. The originating call server 16 communicates with the destination call server 18 to determine which destination gateway 20 is associated with the dialed number, which domain (network) it belongs to, etc., and then conveys IP addressing information to the voice gateway which then uses that information to attach appropriate addressing or forwarding information to the packets to reach the destination edge gateway 20. In other words, the voice gateway which also converts the voice signal from TDM to IP packets, attaches appropriate headers to the packets for addressing the packets to the IP destination. The VoIP packets are then routed over a single path to the destination edge router 22 associated with the destination gateway. In general, routing is performed irrespective of congestion in the IP network, and therefore traffic and available bandwidth are generally not managed optimally. Often, a redundant link is provided between the voice gateway and the edge router for resiliency purposes. The gateway may spread its traffic between the redundant links to edge router(s), but it cannot influence the choice of a path from the edge router to the destination gateway. The voice gateway or call server can assess the availability of the path between the gateway and the edge router for a new call attempt, but the voice gateway, call server and edge router do not have knowledge of whether downstream routers or links are congested or underutilized.

Typically, the originating edge router has a single path to the destination edge over which all voice packets are routed. As is known in the art, it may be configured to select paths based on IP addresses and ports through Equal Cost Multi-Path (ECMP).

One of the shortcomings of current VoIP technology is that call admission is based on the availability of a static route, even when alternate routes, suitable for providing the required QoS, can be found in the network. A technology that addresses this problem remains highly desirable.

### SUMMARY OF THE INVENTION

An object of the present invention is to provide a method and a router for performing adaptive call routing for a packet network, such as Voice Over IP (VoIP). The method and router determine whether either a direct or a two-path route is available through the IP network and if so the new call is admitted into the IP network. If no such route is available, the voice gateway connected to the originating edge router does not admit the new call and either attempts to reroute the call over a different carrier or indicates to the caller that the call cannot be completed as dialed. The method and router involve compiling and updating a route list that specifies every possible direct route or two-path route of connecting one edge router with every other edge router in the virtual network. The routes can be either a single LSP tunnel or a concatenation of two LSP tunnels. The method and router substantially improve the utilization of network by dynamic selection of routes for calls, quality-of-service (QoS) and grade-of-service (GoS) by ensuring that new VoIP calls only admitted into the IP network if they can be handled efficiently and with very minimal probability of packet loss.

Thus, an aspect of the present invention provides a method of adaptively routing voice packets in an IP network. The method includes steps of receiving a request for a new call at a voice gateway, determining a destination gateway for the new call, determining an availability of at least one route for routing the new call across the IP network to the destination gateway, and deciding whether to admit the new call into the IP network based on whether a route is available over which voice packets for the new call can be routed.

Another aspect of the present invention provides a router connected between a voice gateway and an IP network for adaptively routing voice packets through the IP network. The router includes an ingress interface for receiving voice packets from the voice gateway, an egress interface for forwarding voice packets through a virtual tunnel to a destination router connected to a destination gateway, and a route list having a list specifying all possible routes between the router and a plurality of destination gateways to enable the router to signal route availability to the voice gateway so that the voice gateway can decide whether to admit a new call into the IP network.

### BRIEF DESCRIPTION OF THE DRAWINGS

Further features and advantages of the present invention will become apparent from the following detailed description, taken in combination with the appended drawings, in which:

FIG. 1 is a schematic depiction of a VoIP network for routing voice packets from one gateway to another in accordance with the prior art;

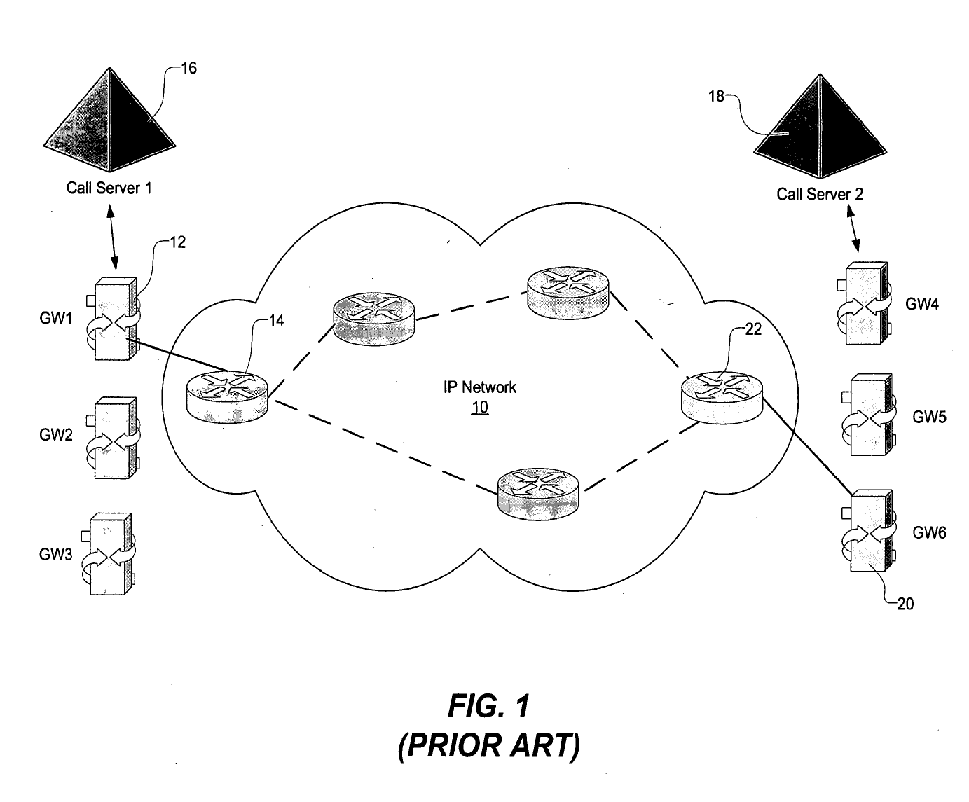

FIG. 2 is a schematic depiction of a virtual network where edge routers have route lists in accordance with an embodiment of the present invention;

FIG. 3 is an schematic depiction of the virtual network of FIG. 2, illustrating the route list that would be constructed if path P23 were overly congested; and

FIG. 4 is a schematic depiction of a router having a route list in accordance with an embodiment of the present invention.

It will be noted that throughout the appended drawings, like features are identified by like reference numerals.

### DETAILED DESCRIPTION OF THE PREFERRED EMBODIMENTS

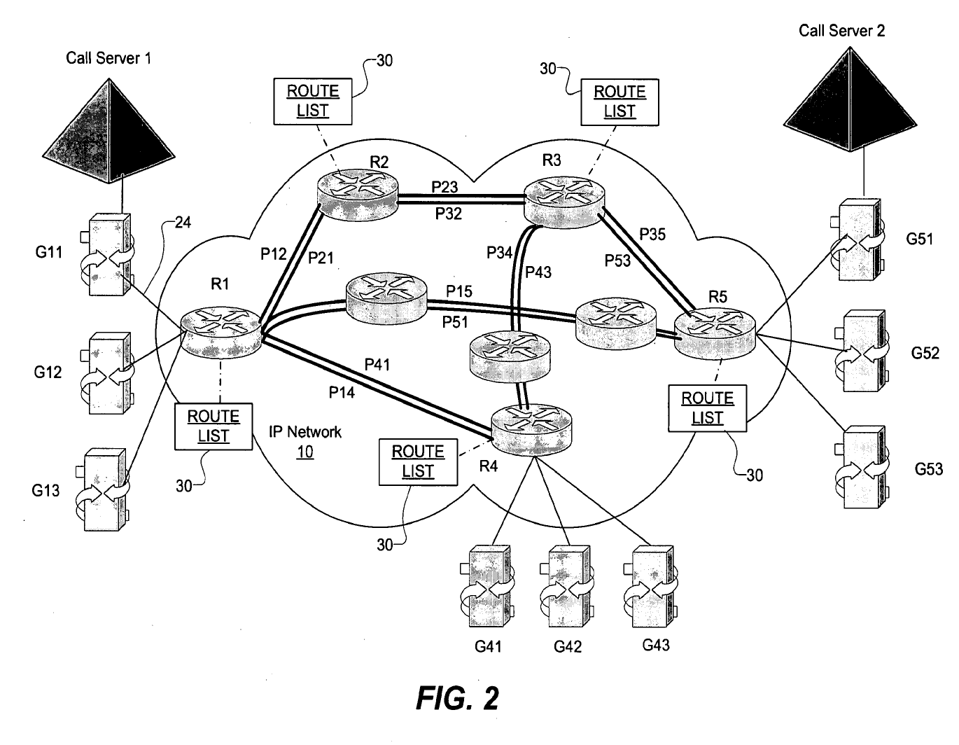

In accordance with a preferred embodiment of the present invention, as shown in FIG. 2, a virtual network is constructed from an IP (Internet Protocol) packet network 10 to include voice gateways, call servers, edge routers connected to the voice gateways, and LSPs (Label Switched Paths) between the edge routers defining the tunnels of the virtual network.

As is known in the art, a Label Switched Path (LSP) is a path or virtual tunnel through an MPLS (Multi-Protocol Label Switching) network that begins at an originating edge router and ends at a destination edge router (and optionally traverses one or more core routers connected together by links). As is known, the path is typically set up using a signaling protocol such as LDP, RSVP-TE, or CR-LDP. At the beginning of the path, a Label Edge Router (LER) or simply an “edge router” prepends a label a packet based on the appropriate FEC (Forwarding Equivalence Class). The edge router then forwards the packet to the next router in the path, which swaps the packet's outer label for another label, and forwards it to the next router. The last router in the path removes (“pops”) the label from the packet and forwards the packet based on the header of its next layer. Since the forwarding of packets through an LSP is opaque to higher network layers, an LSP is also sometimes referred to as an MPLS tunnel.

Typically, LSPs are unidirectional in that they only enable a packet to be label switched through the MPLS network from one endpoint to another. Since bidirectional communication is typically desired, dynamic signaling protocols can set up an LSP in the other direction to enable bidirectionality.

Label Switched Paths provide a circuit-oriented paradigm which provides tunneling to create virtual networks. LSPs provide better control over routing than IGP (Interior Gateway Protocol). An implementation using LSPs allows for non-equal cost paths. Furthermore, it is simpler to provide end-to-end QoS guarantees using an LSP implementation. Moreover, it is easier to monitor LSPs than multi-link paths since the end-to-end tunnel or pipe is conceptualized and monitored as a single “path” even if in reality it is constructed of a concatenation of sequential links or segments.

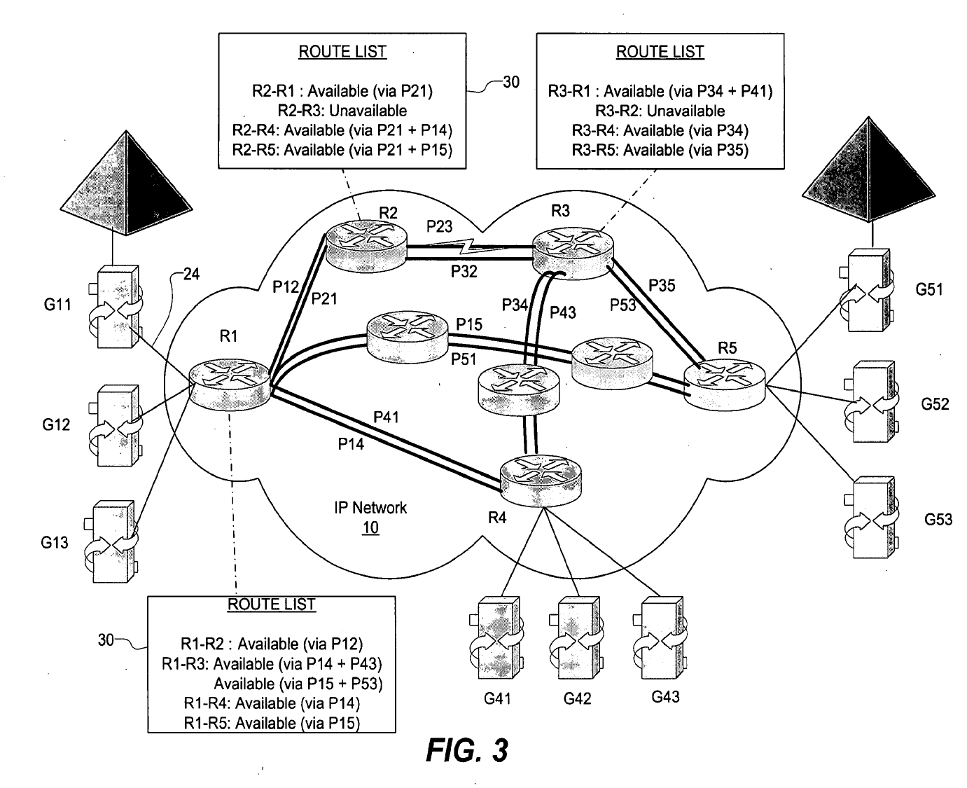

In a virtual network, it is possible to have parallel paths (multiple LSPs) between the same pair of routers. The originating and destination edge routers can be connected by a full mesh of LSPs or by a partial mesh of LSPs. In a partial mesh scenario, such as the one illustrated in FIGS. 2 and 3, calls between some pairs of edge routers may use more than one LSP “leg” or segment, i.e. the calls may be routed over two or more links (two or more hops that typically include being routed via at least one intermediate core router).

Routing calls over two or more paths (“legs”, tunnels or segments) can be done by attaching a proper label stack on the voice packet by the first edge router. For a partial mesh, there is often more than one possible route between originating and destination edge routers. In accordance with one embodiment of the present invention, a method is provided for resolving the question of which route to select for the incoming voice call. As will be explained below, the method also addresses the question of how to admit calls when only the availability of the first leg is known. The method also addresses the related question of how to pass the availability status of the second leg to the ingress router.

In a full mesh scenario, there is a direct path (i.e. a dedicated LSP tunnel) between every pair of edge routers. In practice, however, a full mesh of tunnels may not be feasible or cost-effective because it may result in a huge number of tunnels, some of which are grossly underutilized. Routing calls through multi-path routes (i.e. over a concatenation of paths) may still make sense when the direct route is busy.

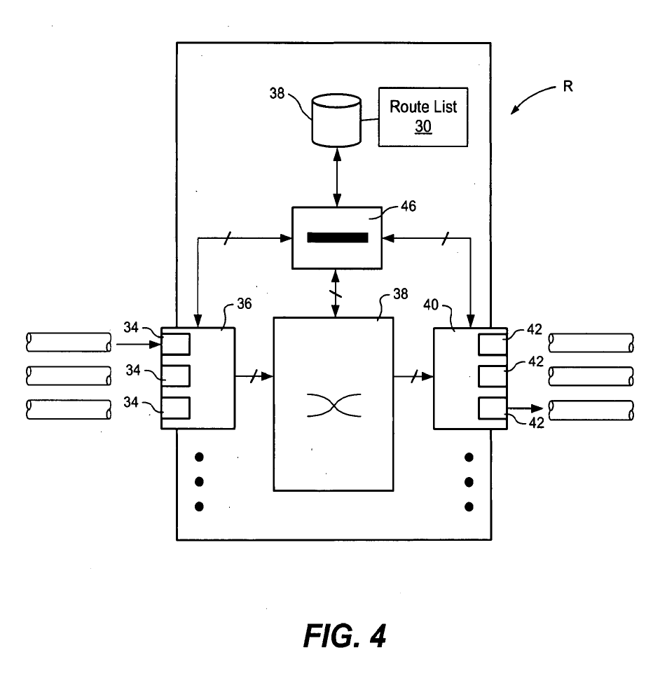

As shown in FIG. 4, each edge router R has a route list 30 stored in a database 38 (or in other electronic storage means) which provides information about how to reach each of the other edge routers in the virtual network. This edge router R can be a simple router having a single, general-purpose processor 46 for processing packets or an advanced router having plural processors for separately performing forwarding and routing functions. Although these terms are often used interchangeably, “forwarding” is a data-plane task whereby packets are switched (through switch fabric 38) from an input port 34 of an ingress interface 36 to an output port 42 of an egress interface 40 (i.e. selecting an output port 42 based on the destination address and routing list) whereas “routing” is a control-plane task of plotting the best path through the network. In other words, routing is the process by which the routing table (and in this present case, the route list) is built. The routing table (or the route list) is built so that the series of local forwarding decisions takes the packet to the destination with high probability and efficiency.

The routing table typically contains a list or lists of Internet addresses and their corresponding location in the network. A router connected to the Internet must identify the interface to be used to reach every other connected router.

The routing table can be manually constructed from information supplied when the router is configured (installed) by the manager or automatically configured using a routing protocol whereby routers periodically exchange information about the contents of their own routing tables by sending packets to each other or by advertising their connectivity information to the other routers in the network. All routers thus become aware of every other router in the network.

Specifically, as shown in FIG. 2, the IP network 10 includes a virtual network constructed of virtual tunnels (e.g. LSPs) interconnecting five edge routers R1, R2, R3, R4 and R5. In this partial-mesh example, router R1 is connected to router R2 via paths P12 and P21 (the paths being virtual tunnels such as, preferably, LSPs). In other words, P12 carries packets from R1 to R2 while P12 carries packets from R2 to R1. Likewise, router R1 is connected to router R4 via paths P14 and P41. Router R1 is also connected to router R5 via paths P15 and P51. In addition to being connected to router R1 via P12 and P21, Router R2 is also connected to router R3 via P23 and P32. In addition to being connected to router R2 via P23 and P32, Router R3 is also connected to router R4 via paths P34 and P43 and to router R5 via paths P35 and P53. Since this is a partial mesh, some router pairs have no dedicated tunnel (no single-path route) because the cost of setting up an LSP for that direct route is not warranted by the amount of traffic expected between those edge routers. In the example shown in FIG. 2, there is no direct route between routers R4 and R5. Packets to be routed between R4 and R5 must take a two-path route such as P41 and P15 or, alternatively, P43 and P35. As will elaborated below, a route that takes three or more paths (such as a four-path route from R4 to R5 via P41+P12+P23+P35) would generally be considered inefficient as it is too circuitous a route between R4 and R5.

For the purposes of this specification, and for consistency of terminology, a “route” connects an originating edge router to a destination edge router. Each route can be direct, i.e. having a single “path” or “tunnel” (a single LSP for example) or the route can be multi-path, i.e. the route can be a concatenation of two or more paths or tunnels (e.g. two or more LSPs). Each tunnel or LSP can have a number of core routers connected by links. By defining LSPs or tunnels, the virtual network does not concern itself with the individual links or “hops” between core routers. However, it should be noted that each LSP of the virtual network does not have to be connected only between edge routers. It is possible to have an LSP connected between an edge router and a core router, or from a core router to an edge router. However, at least one end of an LSP must be an edge router. In that case, a core router that is an ingress of an LSP must advertise the LSP and its availability.

In accordance with an embodiment of the present invention, the edge routers R1, R2, R3, R4, R5 of the virtual network (VN) advertise the voice gateways to which the edge routers are directly linked. For the example shown in FIG. 2, edge router R1 advertises that it is directly linked to voice gateways G11, G12 and G13. Edge router R4 advertises that it is directly linked to voice gateways G41, G42 and G43. Similarly, edge router R5 advertises that it is directly linked to voice gateways G51, G52 and G53.

The edge routers R1, R2, R3, R4, R5 also advertise the LSPs of the virtual network. Specifically, the edge routers advertise the egress node and the ingress label for each LSP, i.e. what the ingress label should be to reach a given destination through that LSP or tunnel. Therefore, the edge routers build, or have configured by an external agent, a route list 30 to each of the other edge routers in the VN. In one embodiment, direct routes (i.e. routes constituted of a single LSP), if any exist, are designated as the first choice while two-path routes (i.e. a concatenation of two LSPs) are designated as the second choice. In other words, given a choice between two different routes, one being direct (a single tunnel) and the other being a two-LSP route (i.e. two tunnels), the router will select the direct route first. If no direct route is available, the router will select an available two-LSP route if such a route is available.

In accordance with a preferred embodiment of the present invention, the route list 30 contains only direct (single-path) routes and two-path (two-LSP) routes. A simplified route list 30 for each of routers R1, R2 and R3 is shown in the example depicted in FIG. 3. For this example, it is assumed that path P23 is so heavily congested that it is effectively unavailable.

Accordingly, the route list 30 for router R1 lists all possible single-path (direct) routes and all possible two-path routes for communicating with the other edge routers R2, R3, R4 and R5. As shown in the simplified route list 30 for router R1, the route between R1 and R2 via path (LSP) P12 is available. There are no two-path routes between R1 and R2. As will explained below, routes having three or more paths are not listed (as being inefficient). For packets traveling from edge router R1 to edge router R3, there is no direct (single-path) route. However, there are three possible two-path routes, namely P12+P23, P15+P53, and P14+P43. However, as P23 is congested, the two-path route P12+P23 is listed in the route list but indicated as unavailable. The other two routes (P15+P53 or P14+P43) are listed and indicated as available. For communications between routers R1 and R4, there is only one direct route (over paths P14 and P41). There are no two-path routes. Multi-path routes having more than three paths exist but are preferably not listed in the route list. For communications between routes R1 and R5, there is a direct route via paths P15 and P51. Again, there are no two-path routes. Multi-path routes having more than three paths exist but are preferably not listed in the route list. The route lists 30 for the other routers are built using the same methodology.

Although multi-path routes having three or more paths (i.e. a concatenation of three or more LSPs) may exist and be available, the preferred method is to exclude these from the route list of each edge router. The rationale for excluding multi-path routes having three or more tunnels is that the utilization of multi-path routes having three or more tunnels is generally inefficient for the network as a whole. In other words, routing a call over a circuitous or “indirect” route (over three or more LSPs) may congest other direct routes, i.e. routes that are direct from the perspective of two other edge routers. The benefits of admitting the call for indirect routing are considered to be outweighed by the cost of clogging the other direct routes of the network. However, although route lists that only contain direct routes and two-LSP routes are preferred, it should be appreciated that in other embodiments of the present invention the route lists may contain multi-path routes having three or more tunnels. Alternatively, the routers may have configurable route lists where the number of tunnels can be varied.

As shown in Table 1 (below), a route list 30 can provide information about the available routes, the paths constituting the routes and which of the paths is unavailable (P23 shown in bold). Optionally, the route list 30 can provide information on the number of hops and the identity of any intermediate core routers, or any other useful parameters or metrics about the links of the virtual network.

TABLE 1
Route List for Router R1 for scenario of FIG. 3

| Route | Type | Path(s) | Availability |
|---|---|---|---|
| R1 → R2 | Direct | P12 | Yes |
| R1 → R3 | Concatenated | P12 + P23 | No |
| | Concatenated | P14 + P43 | Yes |
| | Concatenated | P15 + P53 | Yes |
| R1 → R4 | Direct | P14 | Available |
| R1 → R5 | Direct | P15 | Available |

When a new call attempt arrives at a voice gateway, its destination gateway is obtained through the signaling protocol. In other words, the call server provides the address of the destination gateway. The availability of the link from the gateway to the originating edge router is checked. If the link is not available or is too highly utilized (very high call count), the call is not admitted to the VN. If the link from the gateway to the originating edge router is available, then the originating edge router identifies the destination edge router connected to the destination gateway and selects an available route to that destination edge router.

The edge router then searches its route list 30 either according to the order of the list (fixed route selection) or based on an algorithm (dynamic route selection). However, as noted above, a direct route should be selected in preference to a two-leg route. If no available route is found in the route list, the call may be blocked (not admitted) or the call server may attempt to find an alternate carrier. If an available route is found, a label is attached to each voice and RTCP (Real Time Control Protocol) packet. If a two-leg route is selected, then a two-label stack is attached to each voice and RTCP packet. The first label is used to route the packets to the end of the first leg (whereupon the first label is “popped” or stripped off) revealing the second label which the router then uses to route the packets over the second leg to the ultimate destination.

For the foregoing implementation, the LSPs are assumed to be point-to-point with bandwidth guarantees. In one embodiment, the LSP ingress (router transmitting into the LSP) has a “token bucket”. The concept of the token bucket is used as a control mechanism to determine when packets can be transmitted over an LSP. Tokens are added to the bucket with a rate equal to the LSP bandwidth. Tokens are subtracted with the rate of incoming bytes. The bucket depth is determined based on a maximum acceptable delay for voice packets (e.g. 5 ms). The bucket has two thresholds: a lower threshold and an upper threshold. When the lower threshold is reached, the LSP ingress (router) considers the LSP unavailable. An unavailable LSP is considered to become available when the upper threshold is reached. The purpose of the two thresholds is to prevent the token bucket from “oscillating” between availability and unavailability.

The availability of the path from the voice gateway to the edge router can be assessed by simply counting calls in progress. Since the gateway and/or the call server knows the maximum number of calls that the link can carry, it can readily determine whether the link can accept another call.

In one embodiment, the two thresholds of a token bucket associated with a second leg of a two-leg route may be higher than the respective thresholds of a direct route in order to allow for other network traffic transiting that second leg. Therefore, in this embodiment, a two-leg route will be declared unavailable more readily than a direct route (assuming both the direct route and two-leg route have the same LSP bandwidth and are receiving the same rate of incoming bytes).

Optionally, the token bucket information (thresholds, available bandwidth, incoming byte rate, etc) can also be presented in various formats in the route list(s) 30. This information could be useful for the network manager for refining the embodiments of the present invention.

When an LSP becomes unavailable for alternate routing, the ingress router associated with that LSP informs all other routers in the VN. Likewise, when an LSP becomes available, the ingress router associated with that LSP informs all other routers in the VN.

### Call Admission Decision

The call admission decision is made by either the gateway or call server if the link from the gateway to the edge router is unavailable. Otherwise, if this first link is available, the call admission decision is then made by the edge router based on the availability of the routes listed in the edge router's route list. In other words, the call admission decision is a two-tiered decision, a first (threshold) decision is made by the gateway or the call server based on the availability of the link from the gateway to the edge router (based on whether the call count is less than the maximum call capacity for that link). Provided the link between the gateway and the edge router is carrying less than its maximum capacity, the next decision is based on whether at least one route listed in the edge router's route list is designated as available. The call admission decision (admit or block) is notified to the voice gateway which either (a) packetizes the inbound TDM voice signal into VoIP packets, (b) seeks an alternate carrier or network for the call or (c) notifies the caller that the call cannot be completed as dialed.

There are two techniques for enabling the voice gateway to know when a call should not be admitted into the network, namely (i) gateway-router signaling and (ii) pre-media probing by the gateway.

### (i) Gateway-Router Signaling

In the first technique, the voice gateway asks the originating edge router for a route to the destination gateway for a new call. The phone number dialed for the new call is translated into an IP address of the destination gateway. The originating edge router consults its routing table to determine whether any routes are available. If the originating edge router cannot find an available route in its routing table, the router denies the request for the new call. The voice gateway then asks the call server for further instructions, e.g. whether to reroute the call through another network such as for example on another carrier or whether to simply indicate to the caller that the call cannot be completed as dialed. If, on the other hand, a route is available, i.e. a route is found in the routing table that is designated available, the originating edge router responds to the voice gateway with a label or two labels. If a direct route is available, a single label is returned. If a two-path concatenated route is available, the originating edge router replies with a two-label stack. The first label enables routing through the first tunnel of the two-path route whereas the second label enables routing through the second tunnel. In other words, when the packet is routed to the router defining the end of the first tunnel (LSP), the first label is “popped” (removed), leaving the second label which the router then uses to route the packet over the second tunnel (LSP).

The foregoing technique requires a gateway-router signaling protocol for dynamically assigning each new call with a route corresponding to the destination gateway IP address. For example, User-Network Interface (UNI) defined by the MFA forum can be used.

### (ii) Pre-Media Probing

In the second technique, it is assumed that the edge router has a flow-tracking capability. As is known by those of ordinary skill in the art, flow-tracking entails tracking the flow information of all packets transiting the router. A flow is identified by the quintuple (origination IP address, origination port number, destination IP address, destination port number, protocol id). Once a particular packet having a particular flow identification is tracked, the router will always forward any packet belonging to the same flow in the exact same manner, i.e. to the same next hop (to the same downstream router). If the packet is a new one, i.e. previously untracked, then the router forwards the packet according to one of any number of forwarding paradigms and then logs the flow so that subsequent packets from that flow are forwarded along the same path. The flow tracking mechanism detects an inactive flow by using time-outs. When no packet from a flow traverses the router for a period of time longer than a threshold, the flow is considered inactive and removed from the list.

In this technique, the voice gateway sends two probe packets to the destination gateway. The edge router detects a new flow and consults its route list (forwarding table) to determine if an available route exits through the IP network (“available route” being defined as an available direct, 1-hop route or an available 2-hop route). If the edge router finds an available route in its route list, the edge router attaches one or two appropriate label(s) to the probes and forwards the probe packets. If the edge router cannot find an available route in its route list, then it drops the probe packets.

If the destination gateway receives the probes, it automatically responds to them with acknowledgment packets. If the originating gateway receives at least one of the acknowledgement packets, then the route is deemed available and the call can be safely admitted. Otherwise, if the acknowledgements are not received within a predetermined period of time, the probes are considered to have “timed out” and the call is blocked from being admitted into the IP network.

Probing and acknowledgement can be performed using techniques that are already known in the art. For example, RTCP (Real-Time Control Protocol) can be used to probe by sending APP packets which gateways know how to acknowledge. Alternatively, RTP No-Op packets can be sent to assess the reception quality of a call through interaction with the remote end-point.

Although a single probe packet could be sent, the probability of the probe being lost or corrupted for a spurious reason (i.e. a “false negative”) is considered a bit too high whereas the probability of both probe packets being (i.e. a double false negative) is considered sufficiently remote to be properly indicative of the availability of a route.

Once an affirmative call admission decision is made and an available (one-path or two-path) route is selected, the VoIP packets (which are packetized from inbound TDM voice signals) are forwarded through the LSP tunnel to the destination gateway. When each packet arrives at the originating edge router, the router looks up the packet destination address in its forwarding table to identify the egress port. The router updates the packet header, for example, by decrementing the TTL (Time-to-Live) and updating the header checksum. The router then switches the packet to its egress port where it is buffered in the queue before being transmitted onto an outbound link to the destination edge router (or via intermediate core routers).

Embodiments of this invention enable real-time Quality-of-Service (QoS) routing for multimedia calls. This would include Call Admission Control (CAC) for blocking calls if a QoS path is not found. This results in better per-call QoS/GoS (Quality-of-Service/Grade-of-Service) guarantees and policy treatment.

The embodiments of the invention described above are intended to be exemplary only. The scope of the invention is therefore intended to be limited solely by the appended claims.

1-13. (canceled)

14. A router connected between a voice gateway and an IP network, the router comprising:
a processor configured to:
maintain a route list specifying only single-path routes and two-path routes between the voice gateway and a plurality of destination gateways;
determine an availability of at least one route for routing a new call across the IP network to a selected one of the plurality of destination gateways, based on the route list; and
signal the determined availability to the voice gateway.

15. The router as claimed in claim 14 wherein each path is a Label Switched Path (LSP).

16. The router as claimed in claim 15 wherein the availability of each route is determined using a token bucket where tokens are added to the token bucket with a rate equal to a bandwidth of the route and subtracted from the token bucket at a rate of incoming bytes, wherein the route is determined to be unavailable when the tokens reach a lower threshold of the token bucket and determined to be available when the tokens reach an upper threshold of the token bucket.

17. (canceled)

18. The router as claimed in claim 14 further comprising an ingress interface connected to the voice gateway for receiving a request for a route to a destination gateway and for signaling the determined availability to the voice gateway.

19. The router as claimed in claim 14 wherein the processor is further configured to track packet flows transiting the router.

20. The router as claimed in claim 15 wherein the processor is configured to maintain the route list based on advertisements received from other routers in the IP network, the advertisements advertising LSP availability for at least one LSP connected to each of the other routers.

21. The router as claimed in claim 15 wherein, when a route for routing the new call is determined to be available, the processor is configured to signal the determined availability to the voice gateway by sending a label of the available route to the voice gateway.

22. The router as claimed in claim 19, wherein the processor is further configured to determine the availability of a route by tracking probe packets send through the route, and detecting whether or not response messages are received within a predetermined time-out period, wherein a route is determined to be unavailable when a response message is not received within the predetermined time-out period, and determined to be available when a response message is received within the predetermined time-out period.

23. A non-transitory machine readable storage medium comprising software instructions for controlling a processor of a router connected between a voice gateway and an IP network to perform the steps of:
maintaining a route list specifying only single-path routes and two-path routes between the voice gateway and a plurality of destination gateways;
determining an availability of at least one route for routing a new call across the IP network to a selected one of the plurality of destination gateways, based on the route list; and
signaling the determined availability to the voice gateway.
